(19) United States
(12) Patent Application Publication
(10) Pub. No.: US 2006/0274985 A1
(43) Pub. Date: Dec. 7, 2006

(54) Antifriction bearing comprising integrated lubricating material

(76) Inventors: Martin Engler, LEUTKIRCH (DE); Edmund Foehr, Dab Wurzach (DE); Walter Schumacher-Ruf, Leutkirch (DE)

Correspondence Address: Breneman & Georges, 3150 Commonwealth Avenue, Alexandria, VA, 22305, US

(21) Appl. No.: 10/539,305

(22) PCT Filed: Dec. 12, 2003
(86) PCT No.: PCT/DE03/04125

§ 371 Date: Sep. 16, 2005

(51) Int. Cl. F16C 33/62

(52) U.S. Cl. 384/492

(57) ABSTRACT

The invention relates to an antifriction bearing with integrated lubrication, wherein the surfaces of the parts moved relative to each other are in contact. At least a portion of at least one of the parts has a coating (52, 53) with a lubricant.

The invention relates to an antifriction bearing according to the preamble of Claim 1. High-precision ball bearings with n·Dₘ≧mill (n=speed [RPM], Dₘ=reference circle [mm]) have thus far been used for fast-running devices like compressors, turbines, machining spindles, ball bearings, turbomolecular pumps or the like. Such bearings are routinely lubricated with oil.

In many applications, the lubrication of antifriction bearings with oil poses no significant problem. By contrast, using an oil lubricant is considerably disruptive in special applications if the lubricant can get into sensitive working areas where such lubricants are undesired.

Fast-rotating antifriction bearings are used in a variety of applications, e.g., in dental hand instruments as well. As immediately obvious, the used lubricant can get into the working area of the drill, e.g., by way of the bearing and drill receptacle, thereby entering the cavity to be treated in the mouth of the patient. Even minute quantities of lubricant in a cavity result in a situation where the cavity filling can no longer be adequately guaranteed, because it limits the adhesion of the filling in the cavity, among other things.

However, prior art says that it is absolutely essential to repeatedly lubricate the instruments. Experience here shows that this is normally done at irregular intervals, and even then, excessive oil is frequently supplied, which in turn has a negative impact on operating behavior and service life, wherein the quality of work is also adversely affected by oil that exits during operation in the form of droplets or oil mist.

Known from coating technology are processes with which bodies can be coated. A basic body coated in this way and a coated or uncoated counter-body can then be moved relative to each other during dry running. This movement causes material to be transferred from the coated basic body to the uncoated counter-body, and smoothly breaks in both antifriction surfaces, among other things.

The object of the invention is to provide a fast-rotating antifriction bearing, in particular a miniature bearing, in which the moving structural elements contained therein can be operated at the usual high speeds, while ensuring a low waste heat and high running smoothness, and retaining the previous service life, without the danger of oil leaks, and the described disadvantages of prior art are avoided.

### DESCRIPTION OF THE INVENTION

This object is achieved according to the invention by Claim 1. Advantageous embodiments are described in the subclaims.

An antifriction bearing that requires no lubricant supplied from outside is fabricated using the features according to the invention as described in Claim 1, in which at least a portion of the surface of at least one of the parts is coated with a lubricant.

In the following, “lubricant” is understood to refer undifferentiatedly to all materials that have a lubricating effect.

In the following, “lubricant” is also understood to refer in particular to those lubricating materials not bound in the solid, e.g., oils or greases.

Further on, “lubricant” is also understood to refer to lubricating materials that are bound in a solid and/or can themselves release lubricants.

The coating itself can also be regarded as a lubricant, which is rigidly bound with the basic material, or additionally exhibits at least one intermediate layer, e.g., as the carrier layer.

In the case of a coating that itself releases lubricant, the released quantity is preferably so slight as to be localized essentially in the area of the bearing, even given partial atomization or pulverization, thereby exerting no negative influence on the work result. The advantage to this is that the lubricant is only present at locations where frictional processes take place.

Possible parts include in particular the antifriction bodies, i.e., the bearing balls in the case of ball bearings, and/or the outer ring and/or the inner ring and/or a bearing cage. The running path is here preferably designed according to the invention with regard to the outer and/or inner ring.

Such a solid lubrication can be used to replace the oil as a lubricant, thereby switching to an oil-free concept.

Lubricant is generally always required in cases where the objective is to reduce friction or wear, and/or specifically adjust surface properties. The operator need no longer periodically lubricate the bearing according to the invention, making it possible to avoid service errors during maintenance. In addition, the instruments or devices provided with the bearing are prevented from becoming internally or externally contaminated by lubricant.

When used in a dental instrument, the advantage during treatment is that no lubricant leaks onto the instrument, and so can also not get into the cavity of the patient to be treated. This concept relates to air-driven manual instruments, as well as to hand instruments powered by a motor, in particular an electric motor.

A bearing according to the invention also averts the disruptive influence of oil or its vapor in the other applications mentioned at the outset, e.g., in vacuum technology, in particular in ultrahigh vacuum technology, etc. In addition, the advantage to a bearing according to the invention in all applications is that it eliminates the need for maintenance, at least with respect to lubrication.

One special hurdle encountered during the genesis of the invention had to do with obtaining information about how the smallest components would behave under the specific loads encountered in miniature bearings. Knowledge about the behavior of coatings of the kind currently under study in classic mechanical engineering, in particular material science and coating technology, cannot always be linearly applied to increasingly smaller structural elements due to physical and metallurgical effects. Rather, rising miniaturization is accompanied by a decreasing influence of load, e.g., static loads, and an increasing influence of tolerances, surface finish, crystal and textural structures, metallurgical diffusion processes, etc.

This is also accompanied by the loads typical for the miniature bearings in many applications, e.g., rotations of 40,000 RPM up to and exceeding 400,000 RPM, depending on intended application, which can be achieved in part over several gear stages, e.g., with an overall transmission ratio on the order of approx. 1:5, with the smoothest possible running and low heat generation being required, wherein a high temperature resistance must frequently also be ensured. These loads are increasingly encountered in bearings with n Dₘ≧1 mill. (n=speed [RPM], Dₘ=reference circle [mm]).

It is sufficient for only one component to have a coating, as long as lubrication takes place based on the lubricants provided in the coating, wherein the lubricant can also remain in the coating, in which case no transfer to the uncoated portion takes place.

The advantage to transferring a coating material and the lubricant bound in the coating material simultaneously to the uncoated component from the coated component in a first improvement is that components already coated during production can be integrated in combination with uncoated components. After a run-in phase, the respective contacting surfaces act the same as the surfaces already coated at the outset.

If there are several parts that move relative to each other and require lubrication, it is advantageous to apply a lubricant-conveying coating to at least one of the parts, wherein varying coatings can also be provided. It is here not necessary to actually coat all components that move relative to each other, as long as it is ensured that sufficient lubrication is present at the locations where the relative motion takes place during the rolling process, either by coating only a single component, or conveying material, e.g., in erosion processes.

If the bound lubricant and uncoated counter-surface are designed in such a way that the lubricant adheres to the counter-surface, transferring material from the part bearing the coating to the initially uncoated part smoothens both surfaces, which reduces the operating temperature, and enhances running smoothness.

Another advantage results when the coating has a varying composition from the side of the component to be coated toward the free surface. This makes it possible to set varying functions, such as adhesion of the coating to the basic body on the one hand, and its abrasion resistance with respect to the part moved relative thereto on the other. In addition, the coating is independent of the geometry of the object to be coated.

The advantage to having an elevated amount of lubricant on the free surface of the coating relative to the side of the component to be coated is that the meshing partner is better supplied with lubricant.

The advantage to the improvement in which the coating encompasses at least one carrier layer connected with the surface of the coated part and at least one lubricant layer is that the adhesion of the coating to the part carrying the coating can be specifically adjusted.

If the lubricant from the coating is a solid lubricant, it is possible to ensure that no constituents that might cause contamination are released outside of operation.

If the constituents integrated into the coating can assume a liquid state during operation, it is advantageous to ensure that lubrication takes place only during operation, and only locally.

If the coating encompasses a metal-doped, diamond-like carbon layer (DCL), excellent lubrication is ensured, accompanied by a guaranteed abrasion resistance. The advantage to a metallic carrier layer is that the surface hardness can be specifically adjusted. The surface hardness of the coated part can here be lower.

Coatings that encompass single or multi-sheet polymer layers enable a broad range of application, since the potential of useable organic compounds is extremely high. Of special interest are polymers having a low frictional coefficient, good pressure and flexibility properties, which are also resistant to abrasion and hard. Against this backdrop, PTFE are possible, for example. The surface of such a polymer layer is then the working surface of one of the rolling partners.

In addition, the respective specific properties can be individually and specifically adjusted during the application of several materials, for example, passivation, abrasion resistance, pressure stability, high lubricating effect, layer thickness, layer number, etc. As a polymer coating is brought into contact with an uncoated surface, the conveyance of polymer particles to the previously uncoated side of the meshing partner transfers the specific properties of the respective polymer. In addition, the shape of the object to be coated plays no role with respect to the coating, and another advantage is that such polymer layers form a flat, homogenous surface suitable for use as a rolling surface.

If additional functional layers are also present in the coating, the specific properties of various functional layers can be combined with each other. For example, if one of the layers exerts a pressure-stabilizing effect in that the pressure peaks acting on the coating are distributed in the layers, this improves the endurance and service life of the respective component, and hence the entire instrument.

The coating advantageously exhibits an internal damping that reduces the running noise.

If the coating has an electrical resistance that changes during exposure to wear, the qualitative and quantitative wear state of the coating can be determined based on a change in resistance via the reduction in layer thickness, e.g., as a result of abrasion.

If the coating is electrically insulating, the resistance can be measured to determine whether the assemblies are galvanically separated, as long as enough insulating coating is still present

The advantage to the coating differing visually from the basic material is that the state of wear can be detected in a visually discernible change in the coating.

The fact that wear changes the visual properties of the coating, such as color, brightness (mirror effect) or color intensity, is advantageous in that the intensity of wear can be detected independently of the location of the wear in a visually discernible change in the coating, e.g., run-in tracks.

If the coating reduces the surface hardness owing to the use of a polymer layer, it acts to dampen, which has advantageous effect on running smoothness. However, even though the coating leaves the surface hardness unchanged due to the use of a polymer coating, the polymer coating reduces the frictional resistance. But if the surface hardness is increased, the abrasion rate of the coating can in turn be reduced. The common advantage remains that the coatings can be used among other things to adjust the running properties and abrasion properties.

At least one component in the antifriction bearing is advantageously provided with a corresponding coating, thereby ensuring lubrication. For example, the inner ring and/or outer ring and/or the ball cage and/or the balls can be coated in a ball bearing. Coating only one of the respective parts that move relative to each other reduces the production costs and enables an especially thin functional layer overall via the transfer of material to the uncoated part.

If an additional first unbound lubricant, which corresponds to a second lubricating material, such as grease or oil, or additives with a comparable effect are provided exclusively on the contacting surfaces of the parts, an additional lubricating effect can be achieved with the resultant additional advantages, e.g., improved running smoothness. Given such a combination of lubricating materials, the behavior of the entire system can be adjusted to a wide variety of user requirements.

An additional unbound lubricant with high adhesive and cohesive forces makes it possible to prevent it from moving away from the additionally lubricated surfaces, and wandering into the environment where used, e.g., in the hand instrument or working area of the tool, wherein the adhesive forces act primarily to bond two materials, and the cohesive forces ensure the internal cohesion of the substance. Giving both a high value guarantees that the lubricant can exert its effect with pinpoint accuracy. The result of this in particular is that such a lubricant is applied one time during production, and no more of it need be applied for the life of the product.

The operating behavior can be adjusted with additional parameters if another unbound second lubricant, or a third lubricant, is combined with the already incorporated additional first lubricant, e.g., oil in addition to lubricating grease in the bearing. For example, this makes it possible to reduce friction, and hence operating temperature, even more, and further increase running smoothness.

Designing the bound lubricant as a carrier for the additional unbound lubricant makes it possible to ensure an interaction between the enhancing properties of the respective substances.

It is particularly advantageous if the coating can be sterilized and/or if the additional lubricating materials can be sterilized. Among other things, this makes it possible to achieve the level of sterility required in medicine via sterilization. A high temperature and/or moisture resistance may be of advantage in other areas of applications as well.

If the lubricant of the coating and the additional lubricant are selected in such a way as to be compatible with a lubricant based on prior art, conventional maintenance and lubrication with oil will also not result in a loss of coating properties. Having the lubricant consist of several layers enables a sliding and lubricating effect between the lubricant layers too, thereby enhancing the lubricating capacity.

### BRIEF DESCRIPTION OF DRAWINGS

The drawings show exemplary embodiments of the invention. Shown on:

FIG. 1 is an upper casing of a dental turbine, longitudinal section,

FIG. 2 is an antifriction bearing with shaft and gearing, partially in longitudinal section,

FIG. 3 is the structural design of a multifunctional hybrid layer, and

FIG. 4 is a section through bearing means designed according to the invention.

### EXEMPLARY EMBODIMENT

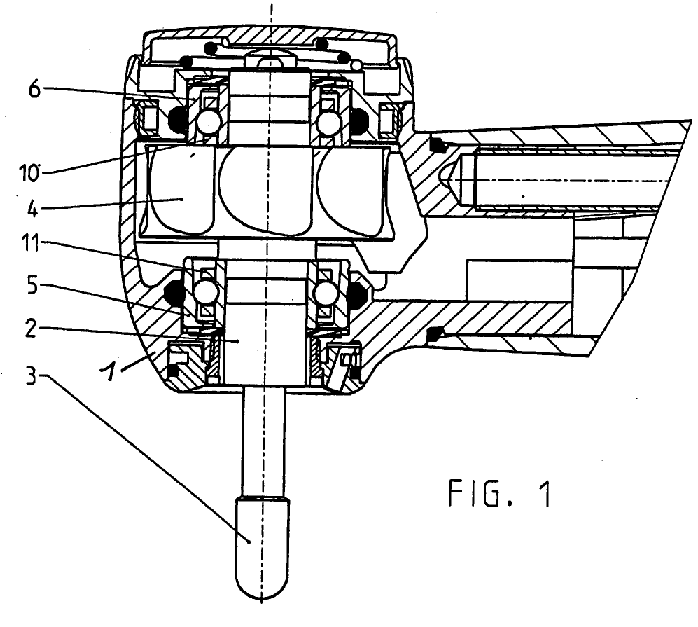

FIG. 1 shows the front part of a dental hand instrument. The figure shows a sectional view of the front part of a dental turbine handpiece with an upper casing 1, which holds a rotor shaft 2 with a rotor 4 for a powered tool 3 in a known manner with antifriction bearings 5, 6. The rolling elements, here balls, are kept spaced apart by a ball cage 10, 11.

In this turbine handpiece, in particular the bearings 5, 6 and/or cages 10, 11 can be coated.

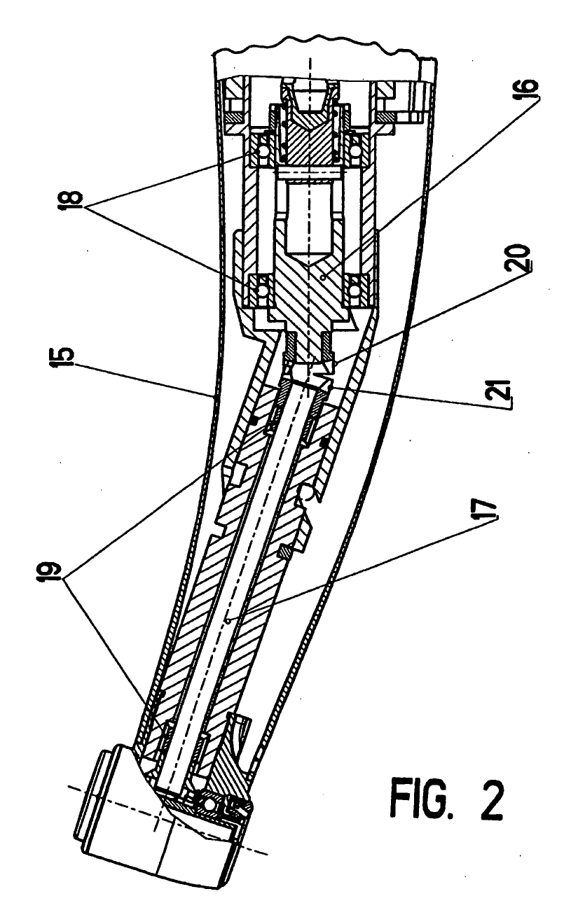

FIG. 2 shows a section of a dental handpiece, in which two drive shaft sections 16, 17 are mounted inside a gripping sleeve 15. Several at least partially coated antifriction bearings 18, here designed as ball bearings 18 and sliding bearings 19 are provided for mounting purposes. The toothed wheelwork of the gearing consists of two toothed wheels 20, 21.

The at least partially coated antifriction bearings 18 can be lubricated with an additional lubricant. However, the antifriction bearings can also be entirely replaced by sliding bearings, wherein a corresponding coating can be provided in this case.

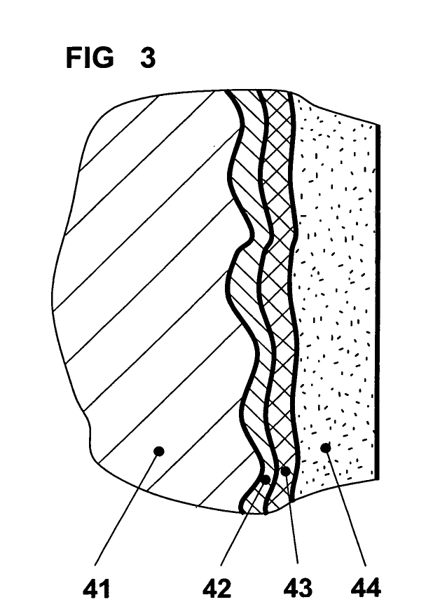

FIG. 3 shows the structural design of a multifunctional hybrid polymer layer as a first variant of the structure of a coating.

A passivation layer 42 is applied to the surface of the basic body 41. A pressure-stabilizing layer 43 is applied over it, followed in turn by a polymer layer 44 as the functional layer. The layers are shown with vertical exaggeration, and the entire layer thickness measures 1-10 μm.

The advantages to a hybrid polymer layer are that each layer can perform a specific function, e.g., passivation, abrasion resistance, pressure stability, high lubricating effect, etc. The coating is independent of the shape of the object to be coated here as well, and the layer thickness and number of layers are individually adjustable. The polymers here form flat, homogeneous surfaces.

The internal structure of the polymer layer can consist of various sheets of the same material. These sheets can ideally support the lubrication via lubricating processes between these sheets. In addition, lubricant bound in the polymer can be incorporated, and unbound lubricating material can also be applied, e.g., during assembly. Lubricating capacity can be precisely set via the interaction of individual layers.

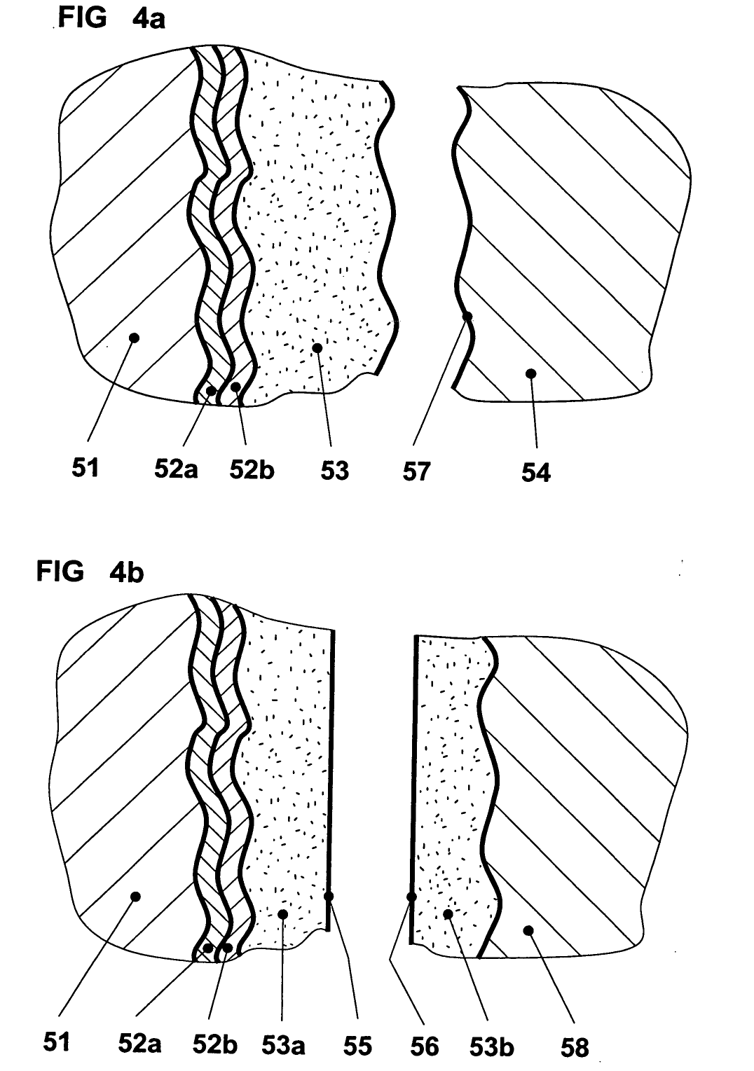

FIG. 4a shows a basic body 51 provided once with a transitional 52a and support layer 52b, on which a functional layer 53 containing or forming the lubricant is in turn applied. The transitional layer 52a establishes the connection to the basic body 51, while the support layer 52b enables pressure compensation. As an alternative, only one or more than two layers 52a, 52b can be used as well. Neither a carrier nor a functional layer is applied to the body 54 lying opposite the functional layer 53.

The rolling process, along with the processes taking place concurrently, yield changes in the coating distribution as shown on FIG. 4b. The rolling procedure conveys material from the functional layer 53 to the opposing body 58, where it is deposited as a functional layer 53b. In addition, bilaterally smoothened antifriction surfaces 55, 56 arise on the functional layer 53a of the basic body 51 or on the functional layer 53b.

The functional layer 53 can be a metal-doped DCL layer. These layers, which are used, for example, as wear protection, prevent contact between the immediate antifriction partners, specifically the basic bodies 51, 54. The properties of the entire functional layer can be individually adjusted via their layers, e.g., the separate layers 52a and 52b. In the case of a first examined variant of such a layer, the functional layer 53 has a frictional coefficient of 0.03.

As a lubricant, here as a dry lubricating layer, the functional layer 53 additionally exhibits features wherein it consists of a lamellar form of modified tungsten-disulfide, and enters into a molecular bond, thereby simultaneously establishing a physical connection with the carrier material. This ends up yielding a protective layer spread out over the entire rolling path, which further has no toxic or corrosive action, and most importantly is compatible with oils, greases, solvents, benzene and alcohol.

A second investigated embodiment of such a surface coating with a metal-doped DCL layer, also referred to as WC/C, involves a hard layer with a dry lubricating property, whose hardness is approx. 1000 HV. The layer structure comprises an intermediate chrome layer and several lamellar WC/C layers. The overall cohesive property of the layers is good. At an overall layer thickness of 1-4 μm the adhesive property is also very good. Such a layer has a temperature resistance of 300° C., along with a theoretical frictional coefficient of 0.2 given a uniformly smooth surface structure.

Depending on the setting, the lubricating plane of the lubrication can be defined by the bound lubricant or the unbound lubricants.

What is claimed is:

1. An antifriction bearing with integrated lubricating material for lubricating parts that move relative to each other, in particular with a respective inner ring that exhibits a running path and an outer ring, between which rolling bodies, in particular bearing balls, are arranged, characterized in that at least a part of the surface of at least one of the parts exhibits a coating (52, 53) of lubricant.

2. The antifriction bearing according to claim 1, characterized in that n·Dₘ≧1 mill. (n=speed [RPM], Dₘ=reference circle [mm]).

3. The antifriction bearing according to claim 1 or 2, characterized in that the lubricant is designed in such a way as to be conveyed from the part carrying the coating to the uncoated part as the parts move.

4. The antifriction bearing according to one of claim 1 or 3, characterized in that the lubricant and the counter-surface (57) of the uncoated part (54) are designed in such a way that the lubricant adheres to the counter-surface of the uncoated part (54).

5. The antifriction bearing according to one of claims 1 to 4, characterized in that the coating exhibits a varying composition (52a, 52b, 53, 42, 43, 44) from the side of the component to be coated toward the free surface.

6. The antifriction bearing according to one of the preceding claims, characterized in that the amount of lubricant on the free surface of the coating (55) is increased with respect to the side of the component to be coated.

7. The antifriction bearing according to one of claims 1 to 6, characterized in that the coating encompasses at least a carrier layer (52a, 42) connected with the surface of the coated part, and at least one lubricant layer (53, 43, 44).

8. The antifriction bearing according to one of claims 1 to 7, characterized in that the lubricant from the coating (53, 44) is a solid lubricant.

9. The antifriction bearing according to one of claims 1 to 8, characterized in that the lubricant has constituents incorporated into the coating (53, 44) that assume a liquid state during operation.

10. The antifriction bearing according to one of claims 1 to 9, characterized in that the coating (53, 44) encompasses a metal-doped, diamond-like carbon layer DCL.

11. The antifriction bearing according to one of claims 1 to 10, characterized in that the coating encompasses a single or multi-sheet polymer layer (42, 43, 44).

12. The antifriction bearing according to one of claims 1 to 11, characterized in that the carrier layer (42, 52a) is metallic.

13. The antifriction bearing according to one of claims 1 to 12, characterized in that the entire coating has additional functional layers (52a, 52b, 42, 43), of which one is pressure-stabilizing.

14. The antifriction bearing according to one of claims 1 to 13, characterized in that one or more layers of the coating have internal dampening.

15. The antifriction bearing according to one of claims 1 to 14, characterized in that the electrical resistance of the coating is altered by wear.

16. The antifriction bearing according to one of claims 1 to 15, characterized in that one of the several layers has an electrically insulating effect.

17. The antifriction bearing according to one of claims 1 to 16, characterized in that the coating differs visually from the basic material (51, 41).

18. The antifriction bearing according to claim 17, characterized in that the visual properties of the coating are altered by wear.

19. The antifriction bearing according to one of claims 1 to 18, characterized in that the coating causes the surface hardness to decrease or remain unchanged.

20. The antifriction bearing according to one of claims 1 to 19, characterized in that at least one component of an antifriction bearing is provided with a corresponding coating.

21. The antifriction bearing according to one of claims 1 to 20, characterized in that at least one component of a sliding bearing is provided with a coating.

22. The antifriction bearing according to one of claims 1 to 21, characterized in that an additional lubricant is provided exclusively on the contacting surfaces of the parts.

23. The antifriction bearing according to one of claims 1 to 22, characterized in that the additional lubricant has high adhesive and cohesive forces.

24. The antifriction bearing according to one of claims 1 to 23, characterized in that an additional, second unbound lubricant is present.

25. The antifriction bearing according to one of claims 1 to 24, characterized in that the lubricant is designed as a carrier for the lubricant(s).

26. The antifriction bearing according to one of claims 1 to 25, characterized in that the coating and/or the additional lubricants can be sterilized.

27. The antifriction bearing according to one of claims 1 to 26, characterized in that the lubricant of the coating (53, 44) and/or the additional lubricant are selected in such a way as to be compatible with a lubricant according to prior art.

28. The antifriction bearing according to one of claims 1 to 27, characterized in that the lubricants consist of several layers.
